(19) United States
(12) Patent Application Publication
(10) Pub. No.: US 2019/0300756 A1
(43) Pub. Date: Oct. 3, 2019

(54) RESIN COMPOSITION FOR FLAT CABLE-REINFORCING TAPE, FLAT CABLE-REINFORCING TAPE, AND FLAT CABLE

(71) Applicant: SUMITOMO ELECTRIC INDUSTRIES, LTD., Osaka-shi, Osaka (JP)

(72) Inventors: Shigeyuki TANAKA, Osaka-shi, Osaka (JP); Yutaka FUKUDA, Osaka-shi, Osaka (JP); Shinya NISHIKAWA, Osaka-shi, Osaka (JP); Shoei YONEZAWA, Kanuma-shi, Tochigi (JP); Tatsuo MATSUDA, Kanuma-shi, Tochigi (JP)

(73) Assignee: SUMITOMO ELECTRIC INDUSTRIES, LTD., Osaka-shi, Osaka (JP)

(21) Appl. No.: 16/302,755

(22) PCT Filed: May 23, 2017
(86) PCT No.: PCT/JP2017/019122

§ 371 Date: Nov. 19, 2018

(30) Foreign Application Priority Data
May 26, 2016 (JP) 2016-105702

(51) Int. Cl. C09J 7/35; B32B 27/08; B32B 27/36; B32B 27/40; B32B 27/28; C09J 7/25; H01B 7/08; H01B 3/30; H01B 3/42

(52) U.S. Cl. CPC C09J 7/35; C09J 2481/006; B32B 27/36; B32B 27/40; B32B 27/281; C09J 7/25; H01B 7/08; H01B 3/301; H01B 3/302; H01B 3/306; H01B 3/421; B32B 2457/00; C09J 2203/302; C09J 2467/00; C09J 2475/00; C09J 2479/08; B32B 27/08

(57) ABSTRACT

A resin composition according to an embodiment of the present invention for a flat cable-reinforcing tape contains a polyester, a polyurethane, and a polycarbodiimide, in which the mass ratio of the polyurethane to the polyester is 40/60 or more and 80/20 or less. A flat cable-reinforcing tape according to an embodiment of the present invention includes a base layer containing a resin as a main component and an adhesive layer stacked on the base layer, the adhesive layer containing the resin composition. A flat cable according to an embodiment of the present invention includes one or a plurality of conductors, a pair of covering materials that hold the one or plurality of conductors therebetween, and the flat cable-reinforcing tape.

### TECHNICAL FIELD

The present invention relates to a resin composition for flat cable-reinforcing tape, a flat cable-reinforcing tape, and a flat cable.

The present application claims priority to Japanese Patent Application No. 2016-105702 filed in the Japan Patent Office on May 26, 2016, the entire contents of which is incorporated herein by reference.

### BACKGROUND ART

Flat cables are used as electric wires for internal wiring of electronic devices. Flat cables are each produced by interposing the plurality of conductors arranged side-by-side between two covering materials and integrating them by, for example, heating.

Such a flat cable includes a region where the conductor is exposed at an end portion in the longitudinal direction so as to be connected to, for example, a connector. The exposed region has lower strength than other regions, and a difficulty lies in connecting the region to, for example, a connector on an as-is basis. Thus, a reinforcing tape is bonded to one side of the exposed region (see Japanese Unexamined Patent Application Publication No. 2008-218252).

### CITATION LIST

### Patent Literature

PTL 1: Japanese Unexamined Patent Application Publication No. 2008-218252

### SUMMARY OF INVENTION

According to an aspect of the present invention, a resin composition for a flat cable-reinforcing tape contains a polyester, a polyurethane, and a polycarbodiimide, in which the mass ratio of the polyurethane to the polyester is 40/60 or more and 80/20 or less.

According to another aspect of the present invention, a flat cable-reinforcing tape includes a base layer containing a resin as a main component and an adhesive layer stacked on the base layer, the adhesive layer containing the resin composition.

According to an aspect of the present invention, a flat cable includes one or a plurality of conductors, a pair of covering materials that hold the one or plurality of conductors therebetween, and the flat cable-reinforcing tape.

### BRIEF DESCRIPTION OF DRAWINGS

FIG. 1 is a schematic cross-sectional view of a flat cable-reinforcing tape according to an embodiment of the present invention.

FIG. 2 is a schematic perspective view of a flat cable according to an embodiment of the present invention.

FIG. 3 is a fragmentary end view taken along line A-A of FIG. 2.

### DESCRIPTION OF EMBODIMENTS

### Problem to be Solved by Disclosure

In recent years, flat cables have begun to be used in various environments such as high-temperature environments and high-humidity environments. Flat cable-reinforcing tapes are thus required to maintain high adhesion in the various environments over long periods of time. In this regard, it is difficult for conventional reinforcing tapes to sufficiently maintain adhesion in high-temperature environments and so forth as currently required.

The present invention has been accomplished in light of the foregoing circumstances. It is an object of the present invention to provide a resin composition for a flat cable-reinforcing tape capable of maintaining sufficient adhesion in high-temperature environments over long periods of time and a flat cable-reinforcing tape. It is also an object of the present invention to provide a flat cable having high strength in high-temperature environments.

### Advantageous Effects of Disclosure

A resin composition for a flat cable-reinforcing tape and a flat cable-reinforcing tape of the present invention can maintain sufficient adhesion in high-temperature environments over long periods of time. A flat cable of the present invention has high strength in high-temperature environments.

### DESCRIPTION OF EMBODIMENTS OF PRESENT INVENTION

Embodiments of the present invention are first listed and explained.

To solve the foregoing problems, a resin composition for flat cable-reinforcing tape according to an embodiment of the present invention contains a polyester, a polyurethane, and a polycarbodiimide, in which the mass ratio of the polyurethane to the polyester is 40/60 or more and 80/20 or less.

In general, polyester is often used as a resin composition for the formation of an adhesive layer of a flat cable-reinforcing tape, in some cases. The mixing of polyester with a resin having a high melting point (for example, polypropylene) improves the heat resistance; however, the adhesion is markedly decreased. In contrast, the resin composition for a flat cable-reinforcing tape contains the polyurethane and the polycarbodiimide in addition to the polyester, the mass ratio of the polyurethane to the polyester being within the above range; thus, both of the heat resistance and the adhesion can be enhanced. Specifically, the resin composition for a flat cable-reinforcing tape, in which the mass ratio of the polyurethane to the polyester is within the above range, can inhibit the fluidity of an adhesive layer containing the resin composition for a flat cable-reinforcing tape in high-temperature environments to sufficiently inhibit the flow out of the adhesive layer in high-temperature environments. The resin composition for a flat cable-reinforcing tape contains the polycarbodiimide; thus, cross-linking and so forth seems to occur between the polycarbodiimide and the polyester and between the polycarbodiimide and the polyurethane to improve the heat resistance of the adhesive layer. Carbodiimide groups of the polycarbodiimide seemingly react with water in air to inhibit the hydrolysis of the polyester and the polyurethane. Thus, the resin composition for a flat cable-reinforcing tape can maintain sufficient adhesion in high-temperature environments over long periods of time.

The soft segment of the polyurethane is preferably composed of a polycarbonate as a main component. When the soft segment of the polyurethane is composed of the polycarbonate as a main component, the heat resistance, the wet heat resistance, and so forth can be further improved.

The content of the polycarbodiimide is preferably 0.5 parts or more by mass and 10 parts or less by mass with respect to 100 parts by mass of the total amount of the polyester and the polyurethane. When the content of the polycarbodiimide is within the above range with respect to 100 parts by mass of the total amount of the polyester and the polyurethane, the heat resistance and the effect of inhibiting hydrolysis can be further improved.

The polycarbodiimide preferably contains an isocyanate group. When the polycarbodiimide contains an isocyanate group, cross-linking and so forth seems to occur between polycarbodiimide molecules, between the polycarbodiimide and the polyester, and between the polycarbodiimide and the polyurethane in the presence of water to easily and reliably improve the heat resistance of the adhesive layer.

In the resin composition for a flat cable-reinforcing tape, the ratio (η₂/η₁) of a shear viscosity (η₂) at a shear rate of 100/s and 150° C. to a shear viscosity (η₁) at a shear rate of 0.01/s and the same temperature is preferably 0.01 or less. When the shear-viscosity ratio (η₂/η₁) is equal to or less than the upper limit, the fluidity of the adhesive layer in high-temperature environments can be more accurately inhibited to easily and reliably inhibit the flow out of the adhesive layer in high-temperature environments.

To solve the foregoing problems, a flat cable-reinforcing tape according to another embodiment includes a base layer containing a resin as a main component and an adhesive layer stacked on the base layer, the adhesive layer containing the resin composition.

The flat cable-reinforcing tape includes the adhesive layer that is stacked on the base layer and contains the resin composition; thus, as described above, the flow out of the adhesive layer in high-temperature environments can be sufficiently inhibited to improve the heat resistance and the durability of the adhesive layer. The flat cable including the flat cable-reinforcing tape can, therefore, maintain sufficient adhesion in high-temperature environments over long periods of time.

To solve the foregoing problems, a flat cable according to another embodiment includes one or a plurality of conductors, a pair of covering materials that hold the one or plurality of conductors therebetween, and the flat cable-reinforcing tape.

Because the flat cable includes the flat cable-reinforcing tape, the peeling of the reinforcing tape and the flow out of the adhesive layer in high-temperature environments are sufficiently inhibited, so that the flat cable has high strength.

The main component of the outermost layer of each of the covering materials of the flat cable is preferably a poly(phenylene sulfide). When the main component of the outermost layer of each of the covering materials is the poly(phenylene sulfide), the covering materials have improved heat resistance. Thus, the flat cable is more suitable for high-temperature environments. In the case where the main component of the outermost layer of each of the covering materials is the poly(phenylene sulfide) and where the adhesive layer is in contact with the covering materials, the interaction between the polycarbodiimide in the adhesive layer and sulfur atoms in the poly(phenylene sulfide) can further improve the adhesion between the covering materials and the adhesive layer.

In the present invention, the term “shear viscosity” refers to a value measured with a rotational rheometer. The term “main component” refers to a component whose content is highest and, for example, indicates a component whose content is 50% or more by mass.

### DETAILS OF EMBODIMENTS OF INVENTION

A resin composition for a flat cable-reinforcing tape, a flat cable-reinforcing tape, and a flat cable according to embodiments of the present invention are described in detail below with appropriate reference to the drawings.

### <Resin Composition for Flat Cable-Reinforcing Tape>

The resin composition for a flat cable-reinforcing tape (hereinafter, also referred to simply as a “resin composition”) contains a polyester, a polyurethane, and a polycarbodiimide, in which the mass ratio of the polyurethane to the polyester is 40/60 or more and 80/20 or less.

In general, a polyester is often used as a resin composition for the formation of an adhesive layer of a flat cable-reinforcing tape. The mixing of the polyester with a resin having a high melting point (for example, a polypropylene) improves the heat resistance; however, the adhesion is markedly decreased. In contrast, the resin composition contains the polyurethane and the polycarbodiimide in addition to the polyester, the mass ratio of the polyurethane to the polyester being within the above range; thus, both of the heat resistance and the adhesion can be enhanced. Specifically, the resin composition, in which the mass ratio of the polyurethane to the polyester is within the above range, can inhibit the fluidity of an adhesive layer containing the resin composition in high-temperature environments to sufficiently inhibit the flow out of the adhesive layer in high-temperature environments. The resin composition contains the polycarbodiimide; thus, cross-linking and so forth seems to occur between the polycarbodiimide and the polyester and between the polycarbodiimide and the polyurethane to improve the heat resistance of the adhesive layer. Carbodiimide groups of the polycarbodiimide seemingly react with water in air to inhibit the hydrolysis of the polyester and the polyurethane. Thus, the resin composition can maintain sufficient adhesion in high-temperature environments over long periods of time.

### (Polyester)

The polyester is a resin having an ester bond in a main chain. Examples thereof include polymers having structural units composed of polycarboxylic acids or their ester-forming derivatives and polyhydric alcohols or their ester-forming derivatives, polymers having structural units composed of hydroxycarboxylic acids or lactones, and copolymers thereof. These may be used alone or in combination of two or more. A known polyester may be used as the polyester. Examples thereof include saturated polyesters such as poly(ethylene terephthalate), poly(propylene terephthalate), poly(butylene terephthalate), poly(cyclohexanedimethylene terephthalate), poly(hexylene terephthalate), poly(ethylene naphthalate), poly(propylene naphthalate), and poly(butylene naphthalate). Examples of polyester copolymers include poly(ethylene terephthalate-sebacate) copolymers, poly(butylene terephthalate-sebacate) copolymers, poly(butylene terephthalate-adipate) copolymers, poly(ethylene terephthalate-succinate) copolymers, poly(ethylene terephthalate-adipate) copolymers, poly(ethylene terephthalate-dodecadionate) copolymers, poly(butylene terephthalate-succinate) copolymers, poly(butylene terephthalate-dodecadionate) copolymers, poly(hexylene terephthalate-succinate) copolymers, poly(hexylene terephthalate-adipate) copolymers, poly(hexylene terephthalate-sebacate) copolymers, and poly(hexylene terephthalate-dodecadionate) copolymers. The polyester may be an unsaturated polyester having a structural unit originating from an unsaturated polycarboxylic acid such as fumaric acid or itaconic acid. The polyester may have a structure originating from another polymerizable monomer as long as the effect of the present invention is not impaired. Specifically, for example, “Vylon GM913”, “Vylon GM915”, or “Vylon GM920”, available from Toyobo Co., Ltd., may be used as the polyester.

The lower limit of the glass transition temperature (Tg) of the polyester is preferably −100° C., more preferably −80° C. The upper limit of the glass transition temperature (Tg) of the polyester is preferably −40° C., more preferably −60° C. If the polyester has a glass transition temperature (Tg) of lower than the lower limit, the adhesive layer containing the resin composition may have insufficient heat resistance. If the polyester has a glass transition temperature (Tg) of higher than the upper limit, the adhesive layer containing the resin composition may have insufficient adhesion. The term “glass transition temperature (Tg)” refers to a value in conformity with JIS-K7121:2012.

The lower limit of the melting point of the polyester is preferably 110° C., more preferably 120° C. The upper limit of the melting point of the polyester is preferably 200° C., more preferably 150° C. If the polyester has a melting point of lower than the lower limit, the adhesive layer containing the resin composition may have insufficient heat resistance. If the polyester has a melting point of higher than the upper limit, a difficulty may lie in molding the resin composition by heating. The term “melting point” refers to a value in conformity with JIS-K7121:2012.

The lower limit of the melt viscosity of the polyester at 200° C. is preferably 450 Pa·s, more preferably 550 Pa·s. The upper limit of the melt viscosity of the polyester is 1,000 Pa·s, more preferably 800 Pa·s. If the melt viscosity is lower than the lower limit, the adhesive layer containing the resin composition may have insufficient heat resistance. If the melt viscosity is higher than the upper limit, a difficulty may lie in molding the resin composition by heating. The term “melt viscosity at 200° C.” refers to a melt viscosity measured with a capillary rheometer at a shear rate of 100 sec⁻¹ and 200° C. in conformity with JIS-K7199:1999 “Plastics-Determination of the fluidity of plastics using capillary and slit-die rheometers”.

The polyester is preferably a crystalline polyester. The crystalline polyester does not readily soften up to near the melting point. Thus, when the polyester is the crystalline polyester, the adhesive layer containing the resin composition has improved heat resistance. The term “crystalline polyester” refers to a polyester in which a melting peak originating from crystals is observed by differential scanning calorimetry (DSC) in conformity with JIS-K7121:1987 “Testing Methods for Transition Temperatures of Plastics”.

### (Polyurethane)

Examples of the polyurethane include various thermoplastic polyurethanes such as polyester-based, polyether-based, and polycarbonate-based thermoplastic polyurethanes. A specific example of the polyurethane is a polymer having a hard segment formed of a polyurethane moiety composed of a diisocyanate such as diphenylmethane diisocyanate (MDI) or tolylene diisocyanate (TDI) and a diol such as ethylene glycol and a soft segment mainly composed of a non-crystalline polymer such as a polyester, a polyether, or a polycarbonate. As the polyurethane, thermoplastic polyurethanes may be used alone or in combination of two or more. In particular, a polymer having a soft segment mainly composed of a polycarbonate is preferred as the polyurethane. When the polyurethane has a soft segment mainly composed of a polycarbonate, the adhesive layer containing the resin composition can have further improved heat resistance, wet heat resistance, and so forth. Specifically, for example, “Pandex T9290N”, available from DIC Covestro Polymer Ltd. and “Miractran E990”, “Miractran E985”, and so forth, available from Nippon Miractran Co. Ltd. may be used as the polyurethane.

The lower limit of the Shore A hardness of the polyurethane is preferably 75, more preferably 85. The upper limit of the Shore A hardness of the polyurethane is preferably 110, more preferably 100. If the polyurethane has a Shore A hardness of less than the lower limit, the adhesive layer containing the resin composition may have insufficient heat resistance and wet heat resistance. If the polyurethane has a Shore A hardness of more than the upper limit, the adhesive layer containing the resin composition may have insufficient adhesion. The term “Shore A hardness” refers to a value in conformity with JIS-K7215:1986.

The lower limit of the total content of the polyester and the polyurethane in the resin composition is preferably 80% by mass, more preferably 85% by mass, even more preferably 90% by mass.

If the total content of the polyester and the polyurethane is less than the lower limit, a difficulty may lie in improving the adhesion of the adhesive layer containing the resin composition while the fluidity of the adhesive layer in high-temperature environments is inhibited. The upper limit of the total content of the polyester and the polyurethane is preferably 95% by mass, more preferably 92% by mass. If the total content of the polyester and the polyurethane is more than the upper limit, the resin composition may have insufficient contents of the polycarbodiimide and so forth, possibly causing the adhesive layer containing the resin composition to have insufficiently high heat resistance.

The lower limit of the mass ratio of the polyurethane to the polyester is, as described above, 40/60, preferably 50/50, more preferably 55/45. The upper limit of the mass ratio is, as described above, 80/20, preferably 70/30, more preferably 65/35. If the mass ratio is less than the lower limit, the fluidity of the adhesive layer containing the resin composition in high-temperature environments may not sufficiently inhibited. If the mass ratio is more than the upper limit, the adhesive layer containing the resin composition may have insufficient adhesion.

### (Polycarbodiimide)

Examples of the polycarbodiimide include aliphatic polycarbodiimides, alicyclic polycarbodiimides, and aromatic polycarbodiimides. In particular, an aliphatic polycarbodiimide having the effect of highly improving the heat resistance is preferred. The polycarbodiimide preferably has an isocyanate group. In the resin composition, when the polycarbodiimide contains an isocyanate group, cross-linking and so forth seems to occur between polycarbodiimide molecules, between the polycarbodiimide and the polyester, and between the polycarbodiimide and the polyurethane in the presence of water to easily and reliably improve the heat resistance of the adhesive layer containing the resin composition.

Examples of the polycarbodiimide containing an isocyanate group include compounds in which hydrogen atoms of polycarbodiimides are replaced with isocyanate groups.

Examples of the polycarbodiimide include polycarbodiimides containing only a carbodiimide group, a linear hydrocarbon group, and an isocyanate group and polycarbodiimides having an alicyclic structure or aromatic ring structure in addition to these groups.

Examples of the polycarbodiimides containing only the carbodiimide group, the linear hydrocarbon group, and the isocyanate group include poly(1,6-hexamethylenecarbodiimide) and poly(diisopropylcarbodiimide).

Examples of the polycarbodiimide further having the alicyclic structure include poly(4,4′-methylenebiscyclohexylenecarbodiimide), poly(1,3-cyclohexylenecarbodiimide), and poly(1,4-cyclohexylenecarabodiimide).

Examples of the polycarbodiimide further having the aromatic ring structure include poly(4,4′-methylenebisdiphenylenecarbodiimide), poly(3,3′-dimethyl-4,4′-diphenylmethanecarbodiimide), poly(naphtylenecarbodiimide), poly(p-phenylenecarbodiimide), poly(m-phenylenecarbodiimide), poly(tolylenecarbodiimide), poly(methylenediisopropylphenylenecarbodiimide), poly(1,3,5-triisopropylbenzene)polycarbodiimide, poly(triethylphenylenecarbodiimide), and poly(triisopropylphenylenecarbodiimide).

The polycarbodiimide preferably has an alicyclic structure, more preferably a cyclohexane structure, from the viewpoint of achieving both good processability and heat resistance.

The lower limit of the content of the isocyanate group in the polycarbodiimide is preferably 0.5% by mass, more preferably 1% by mass. The upper limit of the content is preferably 5% by mass, more preferably 3% by mass. If the content is less than the lower limit, the adhesion of the adhesive layer containing the resin composition may not be sufficiently maintained in high-temperature environments. If the content is more than the upper limit, a cross-linking reaction and so forth may occur excessively to decrease the flexibility of the adhesive layer containing the resin composition.

The lower limit of the content of the polycarbodiimide with respect to 100 parts by mass of the total amount of the polyester and the polyurethane is preferably 0.5 parts by mass, more preferably 1 parts by mass, even more preferably 2 parts by mass. The upper limit of the content is preferably 10 parts by mass, more preferably 8 parts by mass, even more preferably 7 parts by mass. If the content is less than the lower limit, the heat resistance and the effect of inhibiting hydrolysis of the adhesive layer containing the resin composition may not be sufficiently improved. If the content is more than the upper limit, the adhesion of the adhesive layer containing the resin composition and the effect of inhibiting fluidity in high-temperature environments may be insufficient.

The lower limit of the shear viscosity (η₁) of the resin composition at a shear rate of 0.01/s and 150° C. is preferably 1.0×10⁵ Pa·s, more preferably 5.0×10⁵ Pa·s, even more preferably 1.0×10⁶ Pa·s. If the shear viscosity (η₁) is less than the lower limit, the fluidity of the adhesive layer containing the resin composition in high-temperature environments may not be sufficiently inhibited. The upper limit of the shear viscosity (η₁) may be, but is not particularly limited to, for example, 1.0×10⁸ Pa·s.

The upper limit of the ratio (η₂/η₁) of the shear viscosity (η₂) of the resin composition at a shear rate of 100/s and 150° C. to the shear viscosity (η₁) at a shear rate of 0.01/s and the same temperature is preferably 0.01, more preferably 0.001. If the ratio (η₂/η₁) is more than the upper limit, the fluidity of the adhesive layer containing the resin composition in high-temperature environments may not be sufficiently inhibited. The lower limit of the ratio (η₂/η₁) may be, but is not particularly limited to, for example, 0.00001.

### (Other Components)

The resin composition may contain, for example, a resin other than polyester, polyurethane, or polycarbodiimide, a flame retardant, a flame retardant aid, a pigment, an antioxidant, a lubricant, a masking agent, a processing stabilizer, a plasticizer, and a blowing agent as other components, in addition to the polyester, the polyurethane, and the polycarbodiimide.

The flame retardant imparts flame retardancy to the adhesive layer containing the resin composition. Examples of the flame retardant include halogen-based flame retardants such as chlorine-based flame retardants and bromine-based flame retardants.

The flame retardant aid further improves flame retardancy of the adhesive layer containing the resin composition. An example of the flame retardant aid is antimony trioxide.

The pigment is used to color the adhesive layer containing the resin composition. Various known pigments can be used as the pigment. An example thereof is titanium oxide.

The antioxidant prevents oxidation of the adhesive layer containing the resin composition. Various known antioxidants can be used. Examples thereof include phenolic antioxidants.

The lubricant improves the moldability of the adhesive layer containing the resin composition. Various known lubricants can be used. As example thereof is talc.

### <Flat Cable-Reinforcing Tape>

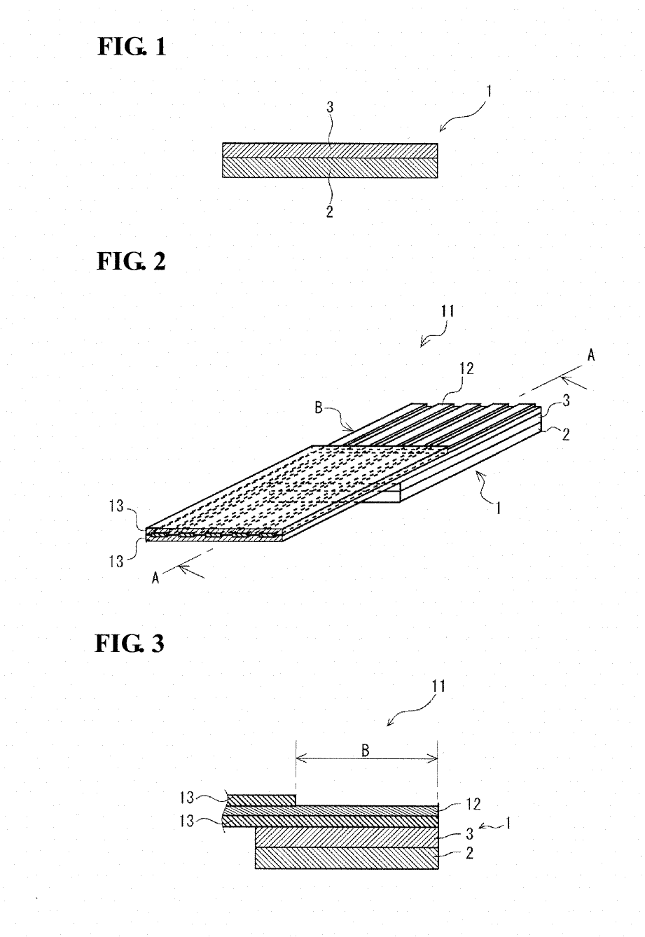

A flat cable-reinforcing tape illustrated in FIG. 1 (hereinafter, also referred to simply as a “reinforcing tape”) 1 includes a base layer 2 containing a resin as a main component and an adhesive layer 3 stacked on the base layer 2, the adhesive layer 3 containing the resin composition. The reinforcing tape 1 includes one outer surface formed of the base layer 2 and the other outer surface formed of the adhesive layer 3. The reinforcing tape 1 is stacked on, for example, a region of the flat cable where one or a plurality of conductors are exposed (hereinafter, also referred to as an “exposed region”).

The reinforcing tape 1 includes the adhesive layer 3 containing the resin composition; thus, the reinforcing tape 1 can sufficiently inhibit the flow out of the adhesive layer 3 in high-temperature environments, and the adhesive layer 3 has improved heat resistance and durability. Accordingly, the reinforcing tape 1 can maintain sufficient adhesion in high-temperature environments over long periods of time.

### (Base Layer)

The base layer 2 contains a resin as a main component, as described above. The base layer 2 may contain another component other than the resin as long as the effect of the present invention is not impaired.

A resin having mechanical strength sufficient to reinforce the exposed region may be used as the resin. The resin preferably has electrical insulation. Examples of the resin include polyesters such as poly(ethylene terephthalate), poly(butylene terephthalate), and poly(ethylene naphthalate); polyamides such as nylon 6, nylon 66, and nylon 610; polyolefins such as polyethylene and polypropylene; acrylic resins such as polyacrylate, polymethacrylate, and polymethyl methacrylate; and polycarbonate, polystyrene, polyimide, polyamide-imide, polyesterimide, polyarylate, poly(ether sulfone), poly(phenylene sulfide), poly(ether ether ketone), and poly(ether sulfide).

The resin is preferably a polyester, more preferably poly(ethylene terephthalate) in view of mechanical strength, the ease of processing, and cost.

The base layer 2 has, for example, a rectangular shape in plan view. The average length and the average width of the base layer 2 may be appropriately set, depending on the size of the exposed region and so forth. The lower limit of the average thickness of the base layer 2 is preferably 20 μm, more preferably 30 μm, even more preferably 50 μm. The upper limit of the average thickness of the base layer 2 is preferably 300 μm, more preferably 250 μm, even more preferably 200 μm. If the average thickness of the base layer 2 is less than the lower limit, the function of protecting the conductors in the exposed region may not be sufficiently improved. If the average thickness of the base layer 2 is more than the upper limit, the thickness of an end portion of the flat cable may be unnecessarily increased, thereby possibly making it difficult to connect the flat cable to, for example, a connector.

The base layer 2 may be subjected to surface treatment in order to enhance adhesion to the adhesive layer 3. An example of the surface treatment is corona treatment. By performing the corona treatment, a polar functional group such as a hydroxy group or a carbonyl group is introduced into a surface of the base layer 2 to impart hydrophilicity to it. The surface treatment may also be performed by another method such as chemical treatment.

In the reinforcing tape 1, a primer layer (adhesion-imparting layer) may further be stacked on a surface of the base layer 2 on which the adhesive layer 3 is stacked. When the primer layer is disposed on the surface of the base layer 2 on which the adhesive layer 3 is stacked, the adhesion between the base layer 2 and the adhesive layer 3 is improved, as with the case where the surface treatment is performed. As the main component of the primer layer, the same resin as that exemplified for the base layer 2 or a urethane resin may be used.

The reinforcing tape 1 may further include a colored layer stacked on a surface of the base layer 2. The colored layer may be stacked on any surface of the base layer 2. The arrangement of the colored layer on the surface of the base layer 2 improves the design characteristics of the reinforcing tape 1. The colored layer may be formed of, for example, a mixture of the resin exemplified for the base layer 2 or a urethane resin and a pigment, a dye, or the like.

The lower limit of the average thickness of each of the primer layer and the colored layer is preferably 0.5 μm, more preferably 1 The upper limit of the average thickness is preferably 50 μm, more preferably 30 μm. If the average thickness is less than the lower limit, the base layer 2 and the adhesive layer 3 may have insufficient adhesion, and the colored layer may be easily damaged. If the average thickness is more than the upper limit, the thickness of an end portion of the flat cable is unnecessarily increased, thereby possibly making it difficult to connect the flat cable to, for example, a connector.

### (Adhesive Layer)

The adhesive layer 3 is composed of the resin composition as described above. The adhesive layer 3 preferably has a sea-island structure in which one of the polyester and the polyurethane forms a sea phase and the other forms an island phase. By using the sea-island structure of the adhesive layer 3, the adhesion is improved, and the fluidity in high-temperature environments is easily and sufficiently inhibited.

The lower limit of the average thickness of the adhesive layer 3 is preferably 10 μm, more preferably 20 μm.

The upper limit of the average thickness of the adhesive layer 3 is preferably 100 μm, more preferably 80 μm. If the average thickness of the adhesive layer 3 is less than the lower limit, the adhesive layer 3 itself may have insufficient adhesion. If the average thickness of the adhesive layer 3 is more than the upper limit, adhesion to the conductors and so forth may be decreased.

The lower limit of the storage modulus of the adhesive layer 3 at 150° C. is preferably 1.0 MPa, more preferably 1.5 MPa, even more preferably 3.0 MPa. If the storage modulus is less than the lower limit, the fluidity in high-temperature environments may not be sufficiently inhibited, and the amount of the adhesive layer 3 flowing out may not be sufficiently reduced when the flat cable is connected to a connector. The upper limit of the storage modulus may be, but is not particularly limited to, for example, 10.0 MPa.

The term “storage modulus” refers to a real term of a complex elastic modulus, which represents the relationship between stress and strain when sinusoidally-varied vibrational strain is applied to a viscoelastic body, and is a value measured with a viscoelastic analyzer (DMS).

### <Method for Producing Reinforcing Tape>

Examples of a method for producing the reinforcing tape 1 include a method in which films for the base layer 2 and the adhesive layer 3 are formed by extrusion molding and the resulting films are stacked and subjected to thermal lamination; a method in which the base layer 2 and the adhesive layer 3 are formed by co-extrusion; and a method in which the adhesive layer 3 is directly arranged on the base layer 2 by extrusion.

In the case of the lamination method, the lower limit of the lamination temperature is preferably 60° C., more preferably 70° C. The upper limit of the lamination temperature is preferably 130° C., more preferably 110° C. If the lamination temperature is lower than the lower limit, the base layer 2 and the adhesive layer 3 may not be sufficiently bonded together. If the lamination temperature is higher than the upper limit, the base layer 2 and the adhesive layer 3 may be thermally deformed.

The lower limit of the lamination speed is preferably 5 m/min, more preferably 10 m/min. The upper limit of the lamination speed is preferably 50 m/min, more preferably 40 m/min. If the lamination speed is less than the lower limit, the productivity of the reinforcing tape 1 may be decreased. If the lamination speed is more than the upper limit, the base layer 2 and the adhesive layer 3 may not be sufficiently bonded together.

### <Flat Cable>

A flat cable 11 illustrated in FIGS. 2 and 3 includes a plurality of conductors 12, a pair of covering materials 13 that hold the plurality of conductors 12 therebetween, and the reinforcing tape 1. In the flat cable 11, the reinforcing tape 1 is stacked in such a manner that the adhesive layer 3 is bonded to one of the covering materials 13 in a region (exposed region B) where at least one side of each of the plurality of conductors 12 is exposed. In the flat cable 11 according to this embodiment, the reinforcing tape 1 is stacked in such a manner that the adhesive layer 3 is bonded to one of the covering materials 13 disposed on a side of the exposed region B opposite the side on which one side of each of the plurality of conductors 12 is exposed. The flat cable 11 is formed as a flexible flat cable having flexibility.

The flat cable 11 includes the reinforcing tape 1, so that the peeling of the reinforcing tape 1 and the flow out of the adhesive layer 3 in high-temperature environments are sufficiently inhibited, resulting in high strength.

### (Conductor)

The conductors 12 are each in the form of a strip. The plurality of conductors 12 extend throughout the entire length of the flat cable 11 in the longitudinal direction. At least one side of each of the plurality of conductors 12 is exposed at both end portions of the flat cable 11 in the longitudinal direction. That is, the flat cable 11 includes a pair of exposed regions B (one of the exposed regions B is not illustrated) at both end portion in the longitudinal direction. Connecting portions for a connector provided on a printed circuit board, an electronic component, or the like are provided in exposed portions of the plurality of conductors 12.

The plurality of conductors 12 are composed of a conductive material. Examples of the main component of the plurality of conductors 12 include conductive metals such as copper, tin-plated annealed copper, and nickel-plated annealed copper.

In particular, the plurality of conductors 12 are preferably formed of a foil-shaped conductive metal. The average thickness of the conductors 12 may be determined, depending on, for example, the amount of current used. When the conductors 12 are in the form of foil, the average thickness is 20 μm or more and 100 μm or less.

### (Covering Material)

The pair of covering materials 13 has insulation. The pair of covering materials 13 functions as protective film of the flat cable 11. The pair of covering materials 13 is used to, for example, improve wear resistance and resistance to voltage. Each of the pair of covering materials 13 may be formed of a single layer or multiple layers. The pair of covering materials 13 may contain other components such as flame retardant.

Examples of the main component of the pair of covering materials 13 include the same resins as exemplified for the base layer 2 of the reinforcing tape 1. Among these, a poly(phenylene sulfide) is preferred in view of its good heat resistance. In particular, the outermost layer that is bonded to the reinforcing tape 1 is preferably composed of the poly(phenylene sulfide) as a main component.

The pair of covering materials 13 has a rectangular shape in plan view, the longitudinal direction of the rectangular shape extending along the axial direction of the plurality of conductors 12. The average length and the average width of the pair of covering materials 13 may be appropriately set, depending on the area of the plurality of conductors 12 arranged. The lower limit of the average thickness of the pair of covering materials 13 is preferably 6 μm, more preferably 9 μm, even more preferably 12 μm. The upper limit of the average thickness of the pair of covering materials 13 is preferably 75 μm, more preferably 50 μm, even more preferably 40 μm. If the average thickness is less than the lower limit, sufficient stiffness may not be ensured. If the average thickness is more than the upper limit, sufficient flexibility may not be ensured.

### (Reinforcing Tape)

The reinforcing tape 1 is provided in such a manner that the adhesive layer 3 is stacked on the outer surface of one of the covering materials 13. In the flat cable 11, the main component of the outermost layer of each of the covering materials 13 is the poly(phenylene sulfide), and the adhesive layer 3 is stacked on an outer surface of one of the covering materials 13, as described above. Thus, the covering materials 13 have improved heat resistance, and the interaction between the polycarbodiimide and sulfur atoms in the poly(phenylene sulfide) can further improve the adhesion between one of the covering materials 13 and the adhesive layer 3.

The lower limit of the peel strength of the adhesive layer 3 to one of the covering materials 13 after a lapse of 1,000 hours from bonding at the temperature of 150° C. is preferably 8 N/10 mm, more preferably 10 N/10 mm, even more preferably 13 N/10 mm. If the peel strength is less than the lower limit, the adhesion between the adhesive layer 3 and the covering materials 13 may be insufficient, possibly failing to provide sufficient stability in high-temperature environments. The term “peel strength” refers to a value measured in conformity with JIS-K6854-2:1999 “Adhesives-Determination of peel strength of bonded assemblies-Part 2: 180° peel”.

### <Method for Producing Flat Cable>

A method for producing the flat cable 11 includes, for example, a step (main body formation step) of forming a flat cable main body by stacking one of the covering materials 13, the plurality of conductors 12, and the other covering material 13 in this order and integrating them by heating under pressure and a step (reinforcing tape bonding step) of bonding the reinforcing tape 1 to one of the covering materials 13 disposed on a side of the exposed region B opposite the side on which at least one side of each of the plurality of conductors 12 is exposed.

### (Main Body Formation Step)

In the main body formation step, the conductors 12 and the covering materials 13 are stacked in such a manner that the plurality of conductors 12 are held between the pair of covering materials 13. At this time, an opening portion is formed in one of the covering materials 13 to form the exposed region B. Subsequently, the resulting stack is heated with, for example, a heat laminator from the outer surface side of the pair of covering materials 13 to form the flat cable main body in which the pair of covering materials 13 is bonded to the plurality of conductors 12.

### (Reinforcing Tape Bonding Step)

In the reinforcing tape bonding step, the reinforcing tape 1 is bonded to at least one end portion of the flat cable main body, formed in the main body formation step, in the longitudinal direction. Specifically, in the reinforcing tape bonding step, the reinforcing tape 1 is disposed so as to be in contact with the outer surface of one of the covering materials 13 on a side (lower side of FIGS. 2 and 3) of the exposed region B opposite the side on which one side of each of the plurality of conductors 12 of the flat cable main body is exposed. Next, in the reinforcing tape bonding step, the reinforcing tape 1 is bonded to the flat cable main body by heating with, for example, a heater from the side of the reinforcing tape 1. As the heater, a known heater may be used.

The lower limit of the heating temperature is preferably 100° C., more preferably 120° C. The upper limit of the heating temperature is preferably 250° C., more preferably 220° C. If the heating temperature is lower than the lower limit, the adhesion between the reinforcing tape 1 and the flat cable main body may be insufficient, possibly causing the reinforcing tape 1 to peel easily. If the heating temperature is higher than the upper limit, the reinforcing tape 1 and the flat cable main body may be thermally deformed.

The lower limit of the heating time is preferably 1 second, more preferably 2 seconds. The upper limit of the heating time is preferably 10 seconds, more preferably 7 seconds. if the heating time is less than the lower limit, the adhesion between the reinforcing tape 1 and the flat cable main body is insufficient, possibly causing the reinforcing tape 1 to peel easily. If the heating time is more than the upper limit, the reinforcing tape 1 and the flat cable main body may be thermally deformed.

The lower limit of the pressure during the heating is preferably 0.01 MPa, more preferably 0.05 MPa. The upper limit of the pressure during the heating is preferably 0.8 MPa, more preferably 0.6 MPa. If the pressure during the heating is less than the lower limit, the adhesion between the reinforcing tape 1 and the flat cable main body is insufficient, possibly causing the reinforcing tape 1 to peel easily from the flat cable main body. If the pressure during the heating is more than the upper limit, the conductors 12 may be damaged in the flat cable main body.

### Other Embodiments

The embodiments disclosed herein are to be considered in all respects as illustrative and not limiting. The scope of the invention is defined not by the configurations of the foregoing embodiments but by the following claims, and is intended to include any modifications within the scope and meaning equivalent to the scope of the claims.

For example, the flat cable does not necessarily include a plurality of conductors and may include only a single conductor. The flat cable is not necessarily a flexible flat cable having flexibility.

In the foregoing embodiments, the flat cable including the single-layer covering materials has been described as an example; however, the covering materials may each be formed of multiple layers. In the case where each of the covering materials is formed of multiple layers, these layers may have the same composition or different compositions. Each of the innermost layers in contact with the conductors is preferably a covering adhesive layer. The covering adhesive layer serves to bond the multilayer covering materials to the conductors. Examples of the main component of the covering adhesive layer include, but are not particularly limited to, epoxy resins, polyimide, polyester, phenolic resins, polyurethane, acrylic resins, melamine resins, and polyamide-imide.

In the case where each of the covering materials is formed of multiple layers, each of the multilayer covering materials is preferably integrated by lamination before the covering materials and the conductors are stacked. This can reduce displacement during stacking. The same procedure and conditions as those of the lamination for bonding the base layer and the adhesive layer of the reinforcing tape can be used.

In the foregoing embodiments, a procedure including stacking conductors on one of the covering materials and stacking the other covering material on the conductors has been described as an example of a method for producing a flat cable. The formation of the pair of covering materials and the bonding of the covering materials to the conductors may be performed in one operation by co-extruding the pair of covering materials in such a manner that the conductors are held between the covering materials. In place of the foregoing method for bonding the pair of covering materials to the conductors by heating, a method may be employed in which an adhesive is applied to surfaces of the covering materials and the conductors to be stacked and then the covering materials and the conductors are press-bonded. The conductors may be formed on one of the covering materials by bonding copper foil or the like to a surface of the covering material and etching the copper foil or the like. The conductors may be formed on one of the covering materials by masking a surface of the covering material and performing plating.

The method for producing the flat cable may further include, after the formation of the flat cable main body, a step of cutting the flat cable main body into a desired length. In this case, a region where the conductors are exposed may be provided in addition to both end portions of the flat cable main body, and then the flat cable main body may be cut in the exposed region. A region where the conductors are covered with the covering materials may be cut, and then the covering materials in the vicinity of the cut portion may be peeled. As a method for cutting the flat cable main body and a method for peeling the covering materials, known methods may be employed.

### EXAMPLES

While the present invention will be described in more detail below by examples, the present invention is not limited to these examples described below.

### EXAMPLES

### [No. 1]

A polyester having a glass transition temperature (Tg) of −70° C. (“Vylon GM913”, available from Toyobo Co., Ltd.) and a polyurethane having a Shore A hardness of 90 (“Pandex T9290N”, available from DIC Covestro Polymer Ltd.) were mixed together in a mass ratio presented in Table 1 in such a manner that the total amount was 100 parts by mass. Furthermore, polycarbodiimide (“Carbodilite LA1”, available from Nisshinbo Chemical Inc.), talc having an average particle size of 8.0 μm (“Micro Ace K-1”, available from Nippon Talc Co., Ltd.), and a hindered phenolic antioxidant (“Irganox 1010”, available from Ciba Specialty Chemicals) were mixed thereto in such a manner that the contents thereof with respect to 100 parts by mass of the total amount of the polyester and the polyurethane were as described in Table 1. Thereby, a resin composition for a flat cable-reinforcing tape of No. 1 was prepared.

One surface of a film that was composed of a poly(ethylene terephthalate (“Lumirror”, available from Toray Industries, Inc.) and that had an average thickness of 188 μm was subjected to corona treatment to form a base layer. A film having an average thickness of 0.03 mm was formed by extrusion molding with the foregoing resin composition, thereby forming an adhesive layer.

The adhesive layer was stacked on the corona-treated surface of the base layer. The base layer and the adhesive layer were bonded to each other by heating from both of the base layer side and the adhesive layer side with a heater, thereby forming a flat cable-reinforcing tape of No. 1. The heating conditions during the bonding were as follows: the temperature of the base layer side and the adhesive layer side was 100° C., and the speed was 10 m/min.

### [Nos. 2 and 3]

Resin compositions for flat cable-reinforcing tapes of Nos. 2 and 3 were prepared as in No. 1, except that the mass ratios of the polyurethane to the polyester were as described in Table 1. The same base layers as that of No. 1 were formed. Adhesive layers that were composed of resin compositions of Nos. 2 and 3 and that had an average thickness of 0.03 mm were bonded to the respective base layers in the same way as in No. 1, thereby forming flat cable-reinforcing tapes of Nos. 2 and 3.

### COMPARATIVE EXAMPLES

### [Nos. 4 to 6]

Resin compositions for flat cable-reinforcing tapes of Nos. 4 to 6 were prepared as in No. 1, except that the mass ratios of the polyurethane to the polyester were as described in Table 1. The same base layers as that of No. 1 were formed. Adhesive layers that were composed of resin compositions of Nos. 4 to 6 and that had an average thickness of 0.03 mm were bonded to the respective base layers in the same way as in No. 1, thereby forming flat cable-reinforcing tapes of Nos. 4 to 6.

TABLE 1

| | | Content with respect to 100 parts by mass of | | |
|---|---|---|---|---|
| | Mass ratio | total amount of polyester and polyurethane | | |
| | Polyurethane/ | [parts by mass] | | |
| | polyester | Polycarbodiimide | Talc | Antioxidant |
| No. 1 | 40/60 | 5 | 3 | 1 |
| No. 2 | 60/40 | 5 | 3 | 1 |
| No. 3 | 80/20 | 5 | 3 | 1 |
| No. 4 | 0/100 | 5 | 3 | 1 |
| No. 5 | 20/80 | 5 | 3 | 1 |
| No. 6 | 100/0 | 5 | 3 | 1 |

### <Shear Viscosity>

The shear viscosity (η₁) [Pa·s] at a shear rate of 0.01/s and the shear viscosity (η₂) [Pa·s] at a shear rate of 100/s of each of the resin compositions of Nos. 1 to 6 were measured at 150° C. with a “RCM302” rotational rheometer available from Anton Paar Japan K.K. Table 2 presents the measurement results of the shear viscosity [Pa·s]. The shear viscosity of each of Nos. 3 and 6 was too high to measure.

### <Storage Modulus at 150° C.>

Measurement was performed with a “DVA-200” dynamic viscoelastic analyzer available from IT Keisoku Seigyo Co., Ltd., at a rate of temperature increase of 10° C./min to determine the storage modulus [MPa] of the adhesive layer of each of Nos. 1 to 6 at 150° C. Table 2 presents the storage modulus. The reinforcing tape of No. 4 started to melt at 150° C., thus failing to measure the storage modulus.

### <Peel Strength>

Each of the reinforcing tapes of Nos. 1 to 6 was stacked on a film that had a thickness of 25 μm and that was composed of a poly(phenylene sulfide) (PPS) (“Torelina”, available from Toray Industries Inc). The reinforcing tape and the PPS film were bonded to each other by heating from both of the reinforcing tape side and the PPS film side with a heater, thereby forming an evaluation sample. The heating and pressing conditions during the bonding were as follows: the temperature of the reinforcing tape side and the PPS film side was 160° C., the heating time was 2 seconds, and the pressure during the heating was 0.3 MPa.

The peel strength [N/10 mm] was evaluated as follows: The evaluation samples were placed in an environment at the temperature of 150° C. The peel strength values of three samples immediately after the bonding of the reinforcing tape were measured. The peel strength values of three samples 1,000 hours later from the bonding were measured. The averages thereof were used for evaluation. The peel strength was measured in conformity with JIS-K6854-2:1999 “Adhesives-Determination of peel strength of bonded assemblies-Part 2: 180° peel”. Table 2 presents the measurement results.

### <Flow-Out Properties>

Adhesive layers that were composed of the resin compositions of Nos. 1 to 6 and that had an average thickness of 30 μm were each interposed between a pair of PPS films having a thickness of 25 μm (composed of “Torelina”, available from Toray Industries Inc). The resulting stack was subjected to hot pressing at 150° C. and a pressure of 0.3 MPa for 3 minutes. The flow-out properties were evaluated according to the following criteria. Table 2 presents the evaluation results.

A: No flow out of the adhesive layer is visually observed.
B: The flow out of the adhesive layer is visually observed.

TABLE 2

| | Shear viscosity | | | | | | |
|---|---|---|---|---|---|---|---|
| | Shear | Shear | | | Peel strength | | |
| | viscosity (η₁) | viscosity (η₂) | Shear | Storage | Immediately | | |
| | at a shear | at a shear | viscosity | modulus | after | 1,000 hours | |
| | rate of 0.01/s | rate of 100/s | ratio | at 150° C. | bonding | later | Flow-out |
| | [Pa · s] | [Pa · s] | (η₂/η₁) | [MPa] | [N/10 mm] | [N/10 mm] | properties |
| No. 1 | 5.8 × 10⁵ | 3.0 × 10³ | 0.0052 | 1.7 | 14.5 | 8.8 | A |
| No. 2 | 3.2 × 10⁶ | 3.0 × 10³ | 0.00094 | 4.2 | 13.7 | 14.5 | A |
| No. 3 | >3.2 × 10⁶ | >3.0 × 10³ | <0.00094 | 8.2 | 10.5 | 11.2 | A |
| No. 4 | 5.1 × 10³ | 2.1 × 10³ | 0.41 | — | 21.1 | 5.0 | B |
| No. 5 | 3.7 × 10⁴ | 2.7 × 10³ | 0.073 | 0.2 | 17.1 | 7.2 | B |
| No. 6 | >3.2 × 10⁶ | >3.0 × 10³ | <0.00094 | 12.0 | 7.2 | 7.5 | A |

### <Evaluation Results>

As listed in Table 2, Nos. 1 to 3 have a high peel strength of 8.8 N or more per 10 mm 1,000 hours later in a high-temperature environment at 150° C. and thus can maintain sufficient adhesion in the high-temperature environment over long periods of time. Table 2 indicates that Nos. 1 to 3 inhibit the flow out of the adhesive layers and that the amount of the adhesive layer flowing out can be sufficiently reduced when they are connected to connectors. In particular, Nos. 2 and 3, in which the mass ratio of the polyurethane to the polyester is in the range of 60/40 to 80/20, have high shear viscosity (η₁) at a shear rate of 0.01/s and 150° C. and high storage moduli at 150° C., which can indicate that the flow out of the adhesive layers in the high-temperature environment is particularly inhibited.

In contrast, Nos. 4 and 5, which have a low polyurethane content, have a low peel strength of 7.2 or less 1,000 hours later in a high-temperature environment at 150° C. Nos. 4 and 5, which have a low polyurethane content, have low shear viscosity (η₁) at a shear rate of 0.01/s and 150° C., a high shear viscosity ratio (η₂/η₁), and low storage moduli at 150° C. This indicates insufficient flow-out properties of the adhesive layers. Although No. 6 has good flow-out properties of the adhesive layer, No. 6, which does not contain polyester, has low peel strength values both immediately after the bonding and 1,000 hours later in a high-temperature environment at 150° C. This indicates insufficient adhesion.

### REFERENCE SIGNS LIST

1 flat cable-reinforcing tape
2 base layer
3 adhesive layer
11 flat cable
12 conductor
13 covering material
B exposed region

1: A resin composition for a flat cable-reinforcing tape, comprising:
a polyester, a polyurethane, and a polycarbodiimide, wherein a mass ratio of the polyurethane to the polyester is 40/60 or more and 80/20 or less.

2: The resin composition for a flat cable-reinforcing tape according to claim 1, wherein a soft segment of the polyurethane is composed of a polycarbonate as a main component.

3: The resin composition for a flat cable-reinforcing tape according to claim 1, wherein a content of the polycarbodiimide is 0.5 parts or more by mass and 10 parts or less by mass with respect to 100 parts by mass of a total amount of the polyester and the polyurethane.

4: The resin composition for a flat cable-reinforcing tape according to claim 1, wherein the polycarbodiimide contains an isocyanate group.

5: The resin composition for a flat cable-reinforcing tape according to claim 1, wherein a ratio (η₂/η₁) of a shear viscosity (η₂) at a shear rate of 100/s and 150° C. to a shear viscosity (η₁) at a shear rate of 0.01/s and the same temperature is 0.01 or less.

6: A flat cable-reinforcing tape comprising:
a base layer containing a resin as a main component; and
an adhesive layer stacked on the base layer, the adhesive layer containing the resin composition according to claim 1.

7: A flat cable comprising one or a plurality of conductors, a pair of covering materials that hold the one or plurality of conductors therebetween, and the flat cable-reinforcing tape according to claim 6.

8: The flat cable according to claim 7, wherein a main component of an outermost layer of each of the covering materials is a poly(phenylene sulfide).
